(19) United States
(12) Patent Application Publication
(10) Pub. No.: US 2016/0086431 A1
(43) Pub. Date: Mar. 24, 2016

(54) GENERATING MYSTERY AWARDS BASED ON VIRTUAL GAME PLAY IN GAMING DEVICES

(71) Applicant: KING SHOW GAMES, INC., Minnetonka, MN (US)

(72) Inventors: Bradley BERMAN, Minnetonka, MN (US); Nathan WODARZ, Eagan, MN (US); Gregg PALMER, Seattle, WA (US)

(21) Appl. No.: 14/862,094

(22) Filed: Sep. 22, 2015

Related U.S. Application Data
(60) Provisional application No. 62/053,397, filed on Sep. 22, 2014.

(51) Int. Cl. G07F 17/32; G07F 17/34

(52) U.S. Cl. CPC G07F 17/3213; G07F 17/3286; G07F 17/3267; G07F 17/34

(57) ABSTRACT

Embodiments of the present invention set forth systems, apparatuses and methods for generating mystery awards based on virtual game play in gaming devices. Accordingly, a gaming device can be configured to generate and present a mystery award option to a player based on virtual game play of the gaming device in a primary or bonus mode. The amount of the mystery award option may be generated within a dynamic range of values and correspond to an expected outcome value of a secondary play option. This mystery award option amount remains hidden from the player until a selection between options is made. As such, the player may select to play in a secondary play option or select the unknown mystery award option while receiving a substantially similar expected outcome value.

### RELATED APPLICATIONS

This application claims the benefit of Provisional Patent Application No. 62/053,397, filed on Sep. 22, 2014, to which priority is claimed pursuant to 35 U.S.C. §119(e) and which is incorporated herein by reference in its entirety.

### FIELD OF THE INVENTION

This disclosure relates generally to games, and more particularly to systems, apparatuses and methods for generating mystery awards based on virtual game play in gaming devices.

BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate generating a mystery award based on virtual game play in gaming devices. Accordingly, a gaming device can be configured to generate and present a mystery award option to a player based on virtual game play of the gaming device in a primary or bonus mode. The amount of the mystery award option may be generated within a dynamic range of values and correspond to an expected outcome value of a secondary play option. This mystery award option amount remains hidden from the player until a selection between options is made. As such, the player may select to play in a secondary play option or select the unknown mystery award option while receiving a substantially similar expected outcome value.

### BRIEF DESCRIPTION OF THE DRAWINGS

FIG. 1 is a diagram of a gaming machine according to embodiments of the invention.

FIG. 2 is a detail diagram of a game display of a gaming device showing an example bonus selection option according to embodiments of the invention.

FIG. 3 is a detail diagram of a game display of a gaming device showing another example bonus selection option according to embodiments of the invention.

FIG. 4 is a detail diagram of a game display of a gaming device showing another example bonus selection option according to embodiments of the invention.

FIG. 5 is a detail diagram of a game display of a gaming device showing another example bonus selection option according to embodiments of the invention.

FIG. 6 is a flow diagram showing an example method of generating mystery credits based on virtual game play according to embodiments of the invention.

FIG. 7 is a flow diagram showing an example method of generating mystery credits based on virtual game play according to embodiments of the invention.

FIG. 8 is a block diagram illustrating a computing arrangement according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing winning result opportunities in gaming activities by generating mystery awards based on virtual game play. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that generate mystery awards based on virtual game play. Here, virtual game play may be simulated game play according to game rules where random outcomes of the simulated game play are used in determining or calculating mystery awards. A gaming device can be configured to generate and present a mystery award option to a player based on virtual game play of the gaming device in a primary or bonus mode. The amount of the mystery award option may be generated within a dynamic range of values and correspond to an expected outcome value of a secondary play option. This mystery award option amount remains hidden from the player until a selection between options is made. As such, the player may select to play in a secondary play option or select the unknown mystery award option while receiving a substantially similar expected outcome value.

Various embodiments utilize different types of virtual game play to generate the one or more mystery awards. In some of these embodiments the virtual game play is completed using substantially similar game rules and elements of the game in the secondary game play option. For example, if the secondary game play option is a pick bonus, the virtual game play may randomly select a number of selections to equal to the number of selections awarded to the player in the pick bonus. The random selections may additionally be from the same table or database used to generate the grid of picks in the pick bonus. In other embodiments where the secondary game play option is a free games bonus, the virtual game play may generate game outcomes using similar reel strips and game play rules to the free games awarded in the secondary game play option. Awards from these virtual outcomes are then accumulated to generate the mystery credit value.

In other embodiments, the virtual game play may include game play that is not related to the game in the secondary play option. This separate virtual game play may be different to force the mystery credit award to fall within a maximum and minimum value range and/or for ease or speed of calculation. For example, in a free games bonus, a five reel game with long reel strips may be used for the actual free spins in the secondary play option while the virtual play may reduce the number of spins, use multipliers or other modifiers, use only three shorter reels, or have any other number of variations from the game in the secondary play option. These variations, however, may be managed so that an expected outcome value of the virtual game substantially matches the expected outcome value of the games in the secondary play option. The modifications and variations in the virtual play may allow for preferential design elements to the mystery credit value, such as controlling the volatility of the mystery credit award, providing for minimum and maximum values for the mystery credit award, or controlling other aspects of the mystery credit award.

The secondary game play option can include any type of wagering game, such as a pick screen bonus game, a free games or free spins bonus, a dice rolling bonus, or even an option in playing a base or primary game on a gaming device. For example, a player may take an option to choose a mystery credit value based on virtual play for a wager value ten times a normal wager value instead of playing ten separate base games. This option may only be available based on certain conditions (such as a streak of five or more losses on the base game, based on a player membership to a casino loyalty program, or based on the outcome of a previous base game), or may always be an option as long as the player has enough credits on the credit meter of the gaming device to cover the larger wager.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

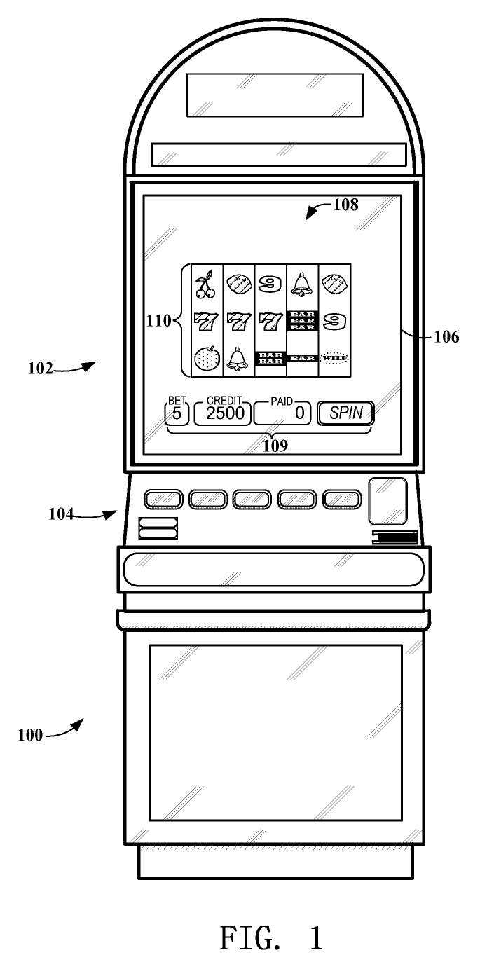

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

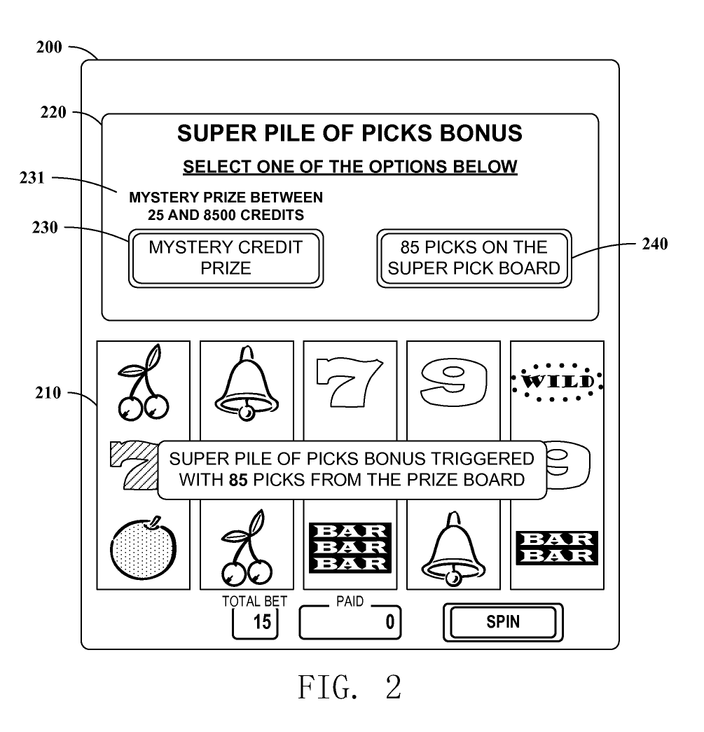

FIGS. 2-5 are detail diagrams of various game displays of gaming devices that show example bonus selection option screens according to various embodiments of the invention. While these bonus selection option screens illustrate different ways that a mystery credit award generated based on virtual game play can be implemented into a wagering game, there are many different embodiments of this concept where the mystery credit award can be utilized, effectuated, or otherwise implemented.

Referring to FIG. 2, a game display 200 includes a game play portion 210 and bonus selection portion 220. The bonus selection portion 220 may appear when a bonus is triggered in the base game on the game play portion 210, or may be triggered by another condition, such as a mystery trigger. As indicated in the game play portion 210, a bonus has been triggered where the player is awarded 85 picks from one or more prize pick screens. As shown in the bonus selection portion 220, however, the player has the option of selecting a mystery credit award instead of the using the 85 picks. To select this option, the player would activate the mystery credit button 230 in the bonus selection portion 220. Alternatively, if the player wanted to make the 85 picks, the player could choose this secondary play option by activating the pick bonus button 240. As indicated by the max/min message 231, the mystery credit award may have a max and min possible value. The maximum and minimum mystery credit values may be predefined, randomly chosen from a table, or may be dynamically calculated based on the number of picks awarded in the pick bonus.

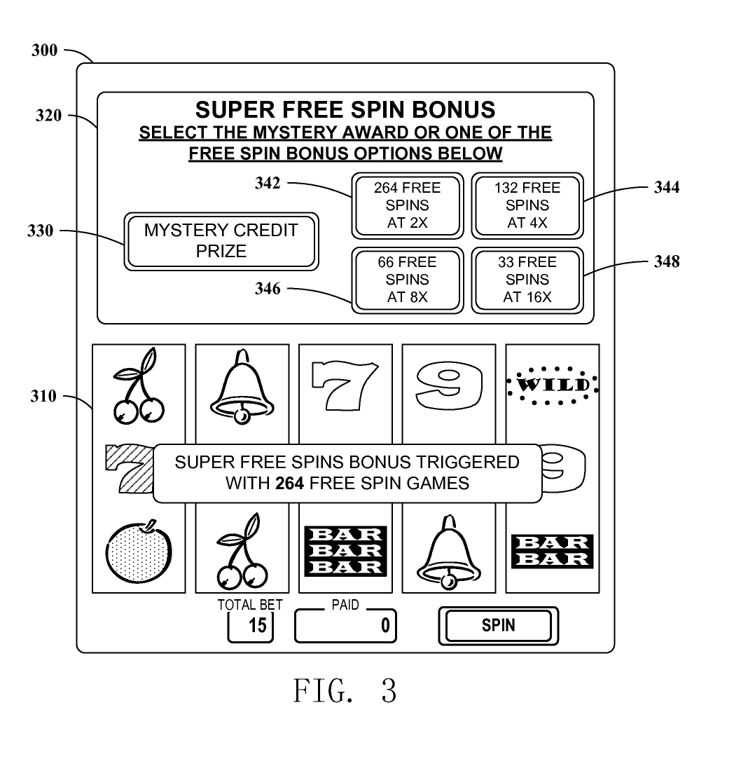

Referring to FIG. 3, a game display 300 includes a game play portion 310 and bonus selection portion 320. The bonus selection portion 320 may again appear when a bonus is triggered in the base game on the game play portion 310, or may be triggered by another condition, such as a mystery trigger. As indicated in the game play portion 310, a bonus has been triggered where the player is awarded 264 free games or free spins. These free games may be carried out in the game play portion 310 using the same game grid and reels, or utilizing a different game grid, reels, and/or game rules. As shown in the bonus selection portion 320, however, the player has the option of selecting a mystery credit award instead of the playing the 264 free games. To select this option, the player would activate the mystery credit button 330 in the bonus selection portion 320. Alternatively, if the player wanted to play the free games, the player would select one of the free spin button options 342, 344, 346, 348. Here, the player has the option of playing the awarded 264 free spins with a “2×” multiplier by pressing the upper left free spin button 342. However, the player could also play 132 free games at a “4×” multiplier by pressing the upper right free spin button 344, play 66 free games at a “8×” multiplier by pressing the lower left free spin button 346, or play 33 free spin games at a “16×” multiplier by pressing the lower right free spin button 348.

These additional free spin game options allow a player to play less free games at a higher multiplier, which can increase the volatility of the bonus as well as shortening the length of time needed to complete the bonus free games. In other embodiments, additional or fewer free spin options may be presented. Additionally, the mystery credit prize may have a maximum and minimum value range provided.

In some embodiments, when an awarded number of free games (or other bonus quantity, such as a number of picks in a pick bonus) in not evenly divisible by the multiplier values associated with the free spin button options 342, 344, 346, 348, remainder games may be played at lower multiplier amounts, or a remainder credit value based on an expected outcome may be presented along with the higher multiplier amounts. For example, if 260 free spins was awarded, the free spin button options 342, 344, 346, 348 may include 260 free spins with a “2×” multiplier, 130 free spins with a “4×” multiplier, 65 free spins with a “8×” multiplier, and 32 free spins with a “16×” multiplier plus one free spin at an “8×” multiplier. Alternatively, the last option could be 32 free spins with a “16×” multiplier plus 4 free spins at a “2×” multiplier, or 32 free spins with a “16×” multiplier plus 25 bonus credits.

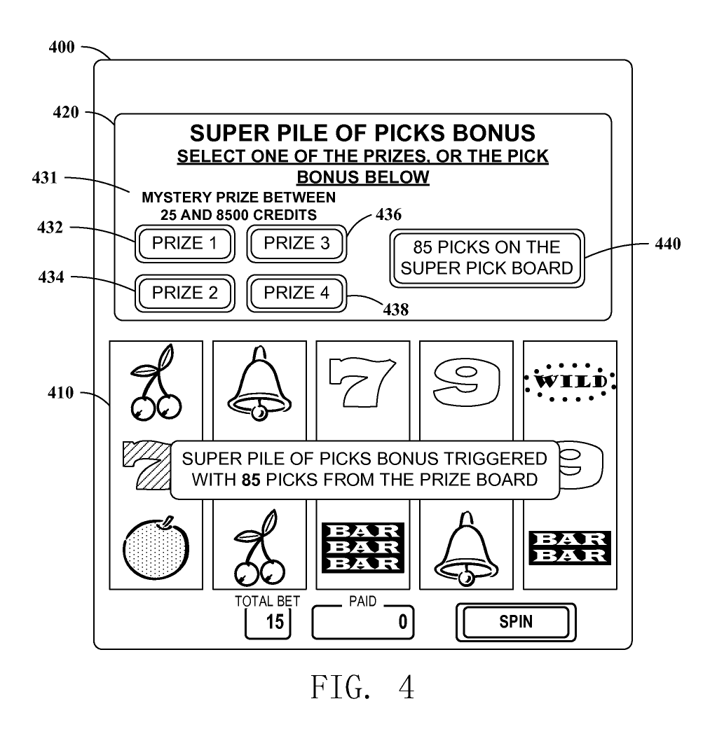

Referring to FIG. 4, a game display 400 includes a game play portion 410 and bonus selection portion 420. The bonus selection portion 420 may appear when a bonus is triggered in the base game on the game play portion 410, or may be triggered by another condition, such as a mystery trigger. As indicated in the game play portion 410, a bonus has been triggered where the player is awarded 85 picks from one or more prize pick screens. As shown in the bonus selection portion 420, however, the player has the option of selecting a mystery credit award instead of the using the 85 picks. To select this option, the player would activate one of the mystery credit buttons 432, 434, 436, 438 in the bonus selection portion 420. Here, a mystery credit value is determined by virtual game play for at least one of the mystery credit buttons 432, 434, 436, 438. The remaining prizes associated with the other mystery credit buttons 432, 434, 436, 438 may be determined based on the first determined mystery credit prize that utilized virtual game play. In other embodiments, however, each mystery credit prize respectively associated with the mystery credit buttons 432, 434, 436, 438 may be independently determined by virtual game play.

Alternatively, if the player wanted to make the 85 picks, the player could choose the secondary play option by activating the pick bonus button 440. As indicated by the max/min message 431, each of the mystery credit awards associated with the mystery credit buttons 432, 434, 436, 438 may have a max and min possible value. In embodiments where one mystery credit prize is determined by virtual game play and the rest of the mystery credit prizes are determined based off of the first mystery credit prize, random values could be added or subtracted to the first determined mystery credit prize value up to the defined maximum and minimum prize values. As discussed above, the maximum and minimum mystery award credit values can be predefined or can be determined dynamically based on factors relating the number of picks awarded in the pick bonus.

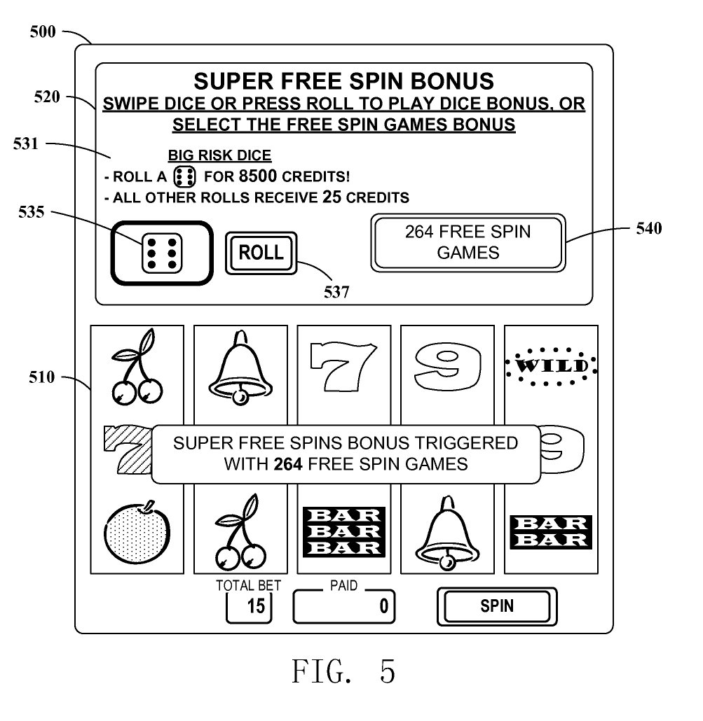

Referring to FIG. 5, a game display 500 includes a game play portion 510 and bonus selection portion 520. The bonus selection portion 520 may again appear when a bonus is triggered in the base game on the game play portion 510, or may be triggered by another condition, such as a mystery trigger. As indicated in the game play portion 510, a bonus has been triggered where the player is awarded 264 free games or free spins. These free games may be carried out in the game play portion 510 using the same game grid and reels, or utilizing a different game grid, reels, and/or game rules. As shown in the bonus selection portion 520, however, the player has the option of selecting a mystery credit award instead of the playing the 264 free games. In this embodiment, the mystery credit award includes a dice roll 531 where the player rolls a single die 535 to determine the credit prize. The player may roll the die 535 by swiping the display screen 500 above the die or by pressing the “Roll” button 537. In this embodiment, rolling a “6” on the die 535 results in a maximum credit prize of 8500 credits. However, rolling any other number of the die 535 results in a minimum prize of 25 credits. Thus, a player has a 1 in 6 chance of receiving a large prize, while the expected outcome value of the dice roll is still kept at a level substantially similar to an expected outcome value of the free games bonus.

This dice roll may be an option in addition to an option of taking a mystery credit prize with less volatility. Additionally, in other embodiments two or more dice may be used where the top prize and the low prizes are balanced by one or more outcomes with intermediary prizes. For example, if two dice were used, a “12” rolled on the dice may give a maximum prize, a “7” rolled may give an intermediary prize, and all other numbers rolled may give a “low” prize. If the player would rather play the 264 free games awarded, the player can activate the free spin button 540. While some example selection screens are shown above, many other variations and layouts are possible that are within the broad scope of this concept.

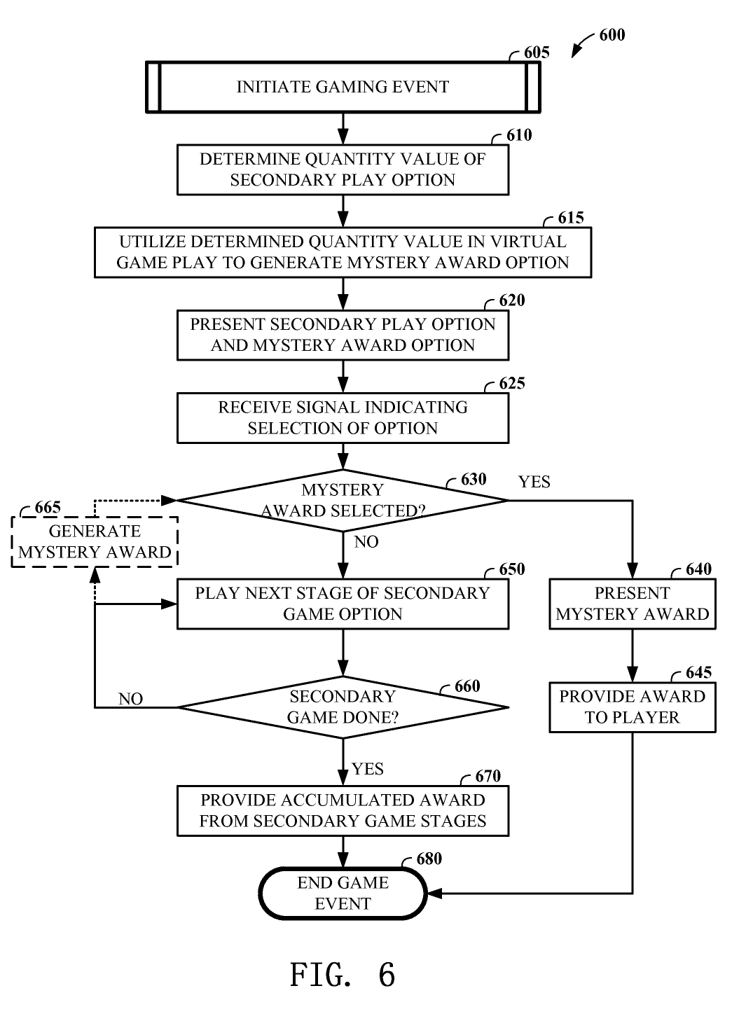

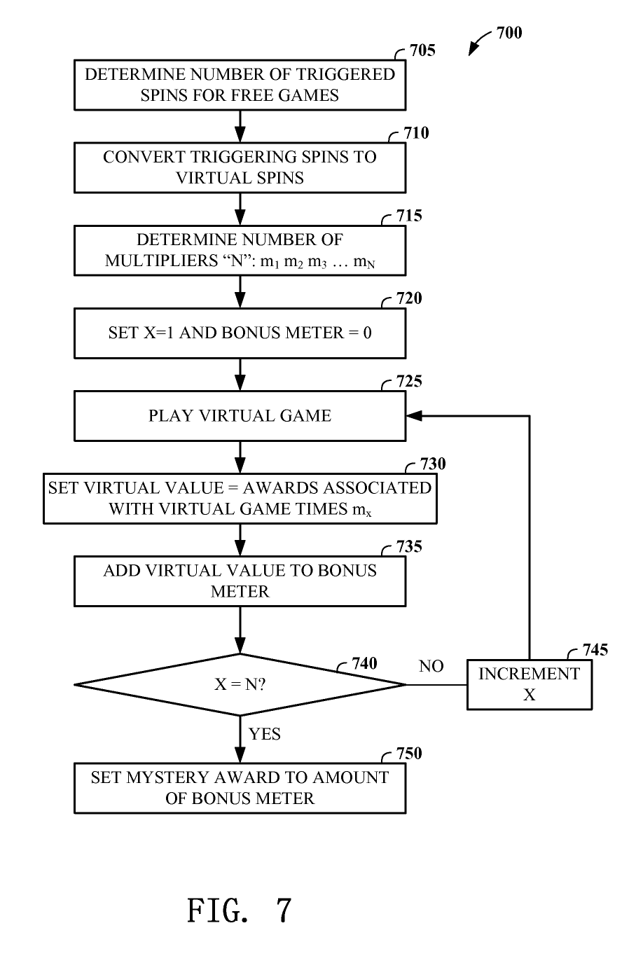

FIGS. 6 and 7 are flow diagrams representing methods in which a gaming device and/or gaming system can be operated according to embodiments of the invention. Although various processes are shown in a particular order in these flow diagrams, the order of these processes can be changed in other embodiments without deviating from the scope or spirit of this concept. Hence, the order of the processes shown is for illustrative purposes only and is not meant to be restrictive. Additional game processes may also be included between various processes even though they are not shown in these flow diagrams for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device. Note that these example methods are just some embodiments of how the steps of a game operation can be implemented. As discussed and shown above, many variations exist which may require additional, fewer, or different processes to complete.

Referring to FIG. 6, flow 600 begins at process 605 where a gaming event is initiated. As described above, the gaming event may be a primary or base game event, where initiation is triggered by receiving a wager and/or a signal (such as from a button actuation) to activate a wagering game. Alternatively, the gaming event may be a bonus gaming event that is triggered based on a satisfied condition during a primary or base game (such as from a resulting symbol combination in the base game or from a mystery trigger).

In process 610, a quantity value of a secondary play option is determined. This quantity value may depend on the type of secondary play option offered in the gaming event. For example, if the secondary play option includes a pick screen bonus, the quantity value may be based on the number of picks awarded in the pick screen bonus. In another example, if the secondary play option includes a free games bonus, the quantity value may be based on the number of free games or free spins awarded in the free games bonus. In other types of base or primary gaming events, the quantity value may relate to a number of paylines played, to a number of credits or coins wagered, to an amount of a side wager, to a number of parallel game screens selected or played, to a number of game reels played, to a type of poker or other game played, or to any other type of measurable quantity that is variable and affects the play or outcome of the secondary play option.

In process 615, a mystery award option is generated based on the determined quantity value by virtual game play. That is, a type of virtual game play is conducted using the determined quantity value from process 610 to generate a mystery award value that is not yet revealed. Here, the virtual game play may be carried out by the game processor in a rapid manner that is virtually undetectable to a player of the gaming device. The virtual game play may be virtual play carried out on a substantially similar game to the secondary play option, or may use another set of game rules in a different game. For example, in a free games bonus option, the virtual game play may run the determined number of awarded free spins on the same game parameters used in the free games bonus to generate a mystery credit value. In another example where the secondary game play is a pick screen, a number of random picks corresponding to a number of awarded picks may be made in the virtual game play to generate the mystery credit value. Many other types of embodiments are possible where virtual game play is used to generate the mystery credit value. Some of these embodiments are discussed in more detail below in conjunction with FIG. 7.

Next, flow 600 proceeds to process 620 where the mystery award option and secondary award option are presented on the display of the gaming device. These options may be visually presented to the player so that the player can select one of the options. In process 625, a signal is received indicating selection of one of the presented options. This signal may be transmitted in response to a player activating a physical or touch-screen button indicating the player's option preference. In some embodiments, an automatic selection may be made by the gaming device. This automatic selection may follow an indicated player option preference (i.e., always take the secondary play option, always take the mystery award, or a predefined combination of the two options), or may be made based on other conditions, such as a timer expiring. The automatic selection may default to either the mystery credit prize, to the secondary play option, or the default selection may follow instructions in a predetermined table or database.

In process 630, the processor determines if the mystery award option has been selected. Alternatively, the processor could determine if the secondary play option has been selected based on the received signal. If the mystery award is selected, flow 600 proceeds to process 640 where the determined mystery award is presented and to process 645 where the value of the mystery award is provided to the player via a credit meter or direct payment. Flow 600 would then conclude at process 680 where the gaming event would end.

If it is determined in process 630 that the secondary play option is selected, flow 600 proceeds to process 650 where the first (or next) stage of the secondary game option is played. This play of the secondary game stage may depend on the type of game associated with the secondary play option. For example, in a free games bonus, each stage of the gaming event may include a single free game. In another example, where the gaming event is a pick screen bonus, each stage may include a single pick in the pick screen bonus. In process 660 it is determined if the secondary game is complete or done. The secondary game may be complete if, for example, no more free games or no more picks remain in a bonus game. Alternatively, the secondary game may end when a “pooper” or “game-ending” icon is received in a secondary game stage. If the secondary game is not complete, flow 600 returns to process 650 to play the next game stage. In some embodiments, an optional process 665 can be implemented to allow a player to choose to take a new mystery prize instead of continuing to play the secondary game. Here, optional process 665 may include calculating, generating, or determining a new mystery credit value that is dependent on the remaining quantity value associated with the secondary game play option. For example, if the player is initially awarded 100 free games and ends up playing 20 of the free games before electing to take a mystery prize, the quantity value used in calculating the new mystery prize value in process 665 may be based on the remaining quantity value of 80 free games. This dynamic generation of a new mystery credit value may be automatically done after each game stage, or may only be done if the player indicates (such as by pressing a button) that they want to take a mystery prize instead of playing the remaining games in the secondary game option. Hence, flow 600 may return to process 630 to determine if a mystery award is accepted after the generation of a new mystery credit value in process 665, or process 665 may be sequentially placed after process 630 so that the new mystery award is not calculated until a player indicates that they want to take the mystery award.

When a player completes play of the secondary games as determined by process 660, the accumulated award from playing the stages of the secondary game is provided to the player in process 670 and flow 600 proceeds to process 680 to end the game event.

FIG. 7 illustrates processes used in some embodiments to generate a mystery award value used in a mystery award option based on virtual game play utilizing a determined quantity value. That is, the flow diagram of FIG. 7 illustrates various processes that can be included in process 615 of FIG. 6 described above. For the sake of clarity and example, the processes of FIG. 7 focus on a secondary gaming event that includes free games. However, the principles of the processes illustrated in FIG. 7 may be used in other types of gaming events where a mystery award is generated based on virtual game play.

Referring to FIG. 7, flow 700 begins at process 705 where the number of triggered free spins is determined for a secondary free games bonus. In process 710, the triggering spins are converted to virtual spins to be used in virtual game play to generate the mystery award. In some embodiments the number of virtual spins is the same as the number of triggering spins, while in other embodiments the number of virtual spins is a function of the number of triggering spins.

For example, the number of virtual spins may be half the number of triggering spins. In process 715 a number of multipliers “N” is determined, where the multipliers are m₁, m₂, m₃, . . . m_{N}. Following process 715, a counter “X” is set to “1” and a bonus meter is set to “0” in process 720.

A virtual game is played in process 725. As described above, the virtual game may be a virtual version of the free game used in the secondary play option (i.e., the same reel strips, etc.), or may be one of many different types of virtual games with random outcomes. In process 730, a virtual award value is set to the awards associated with the outcome of the virtual game multiplied by the m_{X}. That is the multiplier corresponding to the counter number is multiplied by the outcome value in the virtual game. The virtual award value is then added to the bonus meter in process 735.

In process 740, it is determined if X=N. If X does not equal N, X is incremented in process 745 and flow 700 returns to process 725 to play another virtual game. If X does equal N, flow 700 proceeds to process 750 where the mystery award is set to the amount or value of the bonus meter.

A more specific example of these processes shown in FIG. 7 is described below for the purposes of illustrating operations of a novel gaming device. However, many other embodiments are possible in the scope of this invention. One of the aspects of this embodiment is to mimic a free spins bonus without some properties which may be viewed as drawbacks. For example, in some cases it may be desirable to have a minimum and maximum value set for the mystery award. In free spins bonuses (especially ones with retrigger possibilities) the resulting mystery credit award may be extremely high or low, which may not seem reasonable to a player that does not see the actual outcomes of the virtual games being played. Additionally, for purposes of confirming accuracy of calculations used to determine the mystery value by virtual play, even if it is relatively simple to determine the extreme values of a particular spin, it may still be substantially impossible to proscribe such bounds for the entire bonus when retriggers are allowed. While predefining a minimum and maximum value for the mystery credit is possible, it can, in some instances, improperly skew the expected outcome value of the mystery credit option from the expected outcome value of the secondary play option. The following example process provides a solution to this issue by using substitutes for a free games bonus while providing the same expected return. To allow for this and avoid the indicated shortcomings, the procedure separates the concepts of retrigger from the credit value associated to a spin.

For the following example process, “T” will represent the initial number of triggering spins, and “E” represents the expected number of spins when triggering a free games bonus with 1 spin.

### Example Process:

1. The player triggers a bonus with T triggering spins. At this point, the player is given a choice between a free games bonus with T spins or the Mystery Credits option. The player will be shown a minimum value and a maximum value for the Mystery Credits option, both of which are dynamically determined by the value T through an algorithm described below.
2. The triggering spins T are converted into a number “V” of “Virtual Spins.” A Virtual Spin is meant to simulate the process of retriggering in the free games bonus, and V corresponds to the number of free games after all retriggers have been fully resolved. There is a cap on the value of V so that V/T≦C, where “C” is greater than the expected value of V/T, which is E[V/T]=E. One possible determination of V when C=2 is described.
   a. If T is even, initialize V=0. Otherwise, set T=T−1 and initialize V to a weighted random choice of 1 and 2.
   b. By weighted random choice, determine whether 2T should be added to V. If so, the process concludes with this value for V. Otherwise, the process continues.
   c. If T>0, set T=T−2 and add either 2 or 3 to V, again determined by weighted random choice. Repeat this step until T=0.
   d. The value V is the number of Virtual Spins.
   e. Note: Assuming that the likelihood of retriggering in the free games bonus is constant on every spin, the expected number of free spins is E×E[T]. The above process is designed so that that it is linear in T, so E[V]=E[V/T]×E[T]=E×E[T].
3.“N” multipliers m₁, m₂, . . . , m_{N}, are determined so that the sum of the multipliers is equal to V and no two multipliers differ by more than 1. The value of N controls the volatility of the Mystery Credits option, with smaller values being more volatile.
4. For each multiplier in the previous step, one bonus spin is taken on a set of reel strips. A value equal to the multiplier times the result of this spin is added to the bonus meter. The reel strip set need not be the same set as the free games bonus, but will have the same expected return per spin, denoted “S”.
   a. Note: These reel strips also need not have the same number of reels or paylines as the free games bonus or the triggering game and should not retrigger the bonus.
   b. Note: Denote the minimum value of a spin by “m” and the maximum by “M.” The minimum and maximum values described in Step 1 are m×T and M×C×T, respectively. (Both are also multiplied by the bet per line, if applicable).
   c. Note: The expected value of the Mystery Credits bonus is E[V]×S, the expected value of V times S. Since E[V]=E×E[T], the expected value is equal to E×E[T]×S, which is the expected value of the free games bonus.

In one example: A bonus is set up so that m=5, M=75, C=3, and N=4. The player triggers with T=30 spins. The player will be shown a minimum value of 150 credits and a maximum of 6750 credits. Suppose that the outcome of Step 2 results in V=50 virtual spins. The multipliers in Step 3 are then 13, 13, 12, and 12. The bonus reel strips are spun four times. If the results of these spins are 12, 75, 40, and 30, the player will be awarded a total of (13×12)+(13×75)+(12×40)+(12×30)=1971 credits.

### Variations:

1. The minimum and maximum prizes need not be determined. In this case, the number of

Virtual Spins need not be capped. This value could then be determined by spinning the usual free games bonus games without displaying them.
2. In Step 2, the Virtual Spins may be determined by multiplying T by a single value from a pick table.
3. In Step 2, the Virtual Spins may be determined by drawing from unique tables for any possible value of T.
4. In Step 2, the Virtual Spins may be determined by spinning a set of reel strips or playing some other game.
5. The multipliers in Step 3 can differ by a larger amount so long as all multipliers are positive integers summing to V.
6. The number of multipliers in Step 3 may be varied, perhaps by player choice, to control the volatility of the bonus.
7. The expected number of Virtual Spins in Step 2 and the expected value of a bonus spin in Step 4 may be varied, so long as the expected value of the final award matches the expected value of the free games bonus.
   a. One extreme case would have V=T. The other extreme case would have the reel strips constructed in such a way as to return a constant value.
8. A free games bonus will often have an additional large Jackpot award, such as a progressive. This Jackpot prize can be awarded inside of the Mystery Credits framework. This involves the following steps.
   a. Reduce the expected value of a bonus spin in Step 4 to that of the free games bonus spin without the Jackpot prize.
   b. For each Virtual Spin from Step 2, make a random draw from a weighted table to determine if the Jackpot should be awarded.
9. Same as the previous Variation, except the Jackpot determination is made by symbols on the bonus strips.
10. Same as the previous Variation, except the Jackpot determination is made by one or more weighted draws.
11. Although T will generally represent a number of free spins, it may also represent a bonus multiplier which is converted into a larger multiplier V.

Although the above process details features of some embodiments, other embodiments may use different processes to achieve similar results and which fall within the scope of this concept.

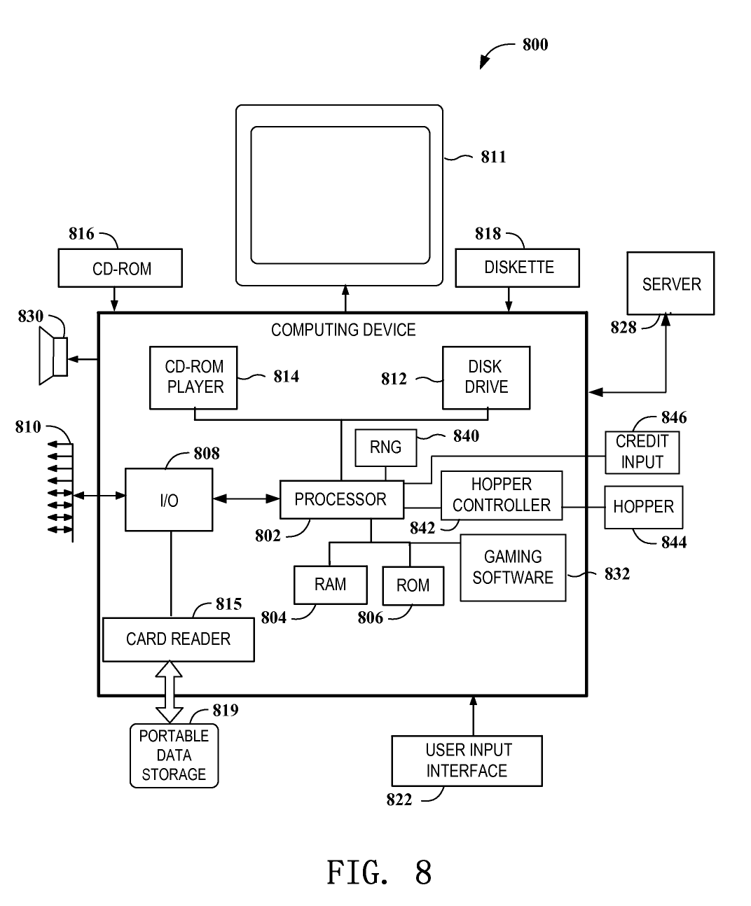

As may now be readily understood, one or more devices may be programmed to play various embodiments of the invention. The present invention may be implemented as a casino gaming machine or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 8.

Hardware, firmware, software or a combination thereof may be used to perform the various gaming functions, display presentations and operations described herein. The functional modules used in connection with the invention may reside in a gaming machine as described, or may alternatively reside, at least in part, on a stand-alone or networked computer. The computing structure 800 of FIG. 8 is an example computing structure that can be used in connection with such electronic gaming machines, computers, or other computer-implemented devices to carry out operations of the present invention.

The example computing arrangement 800 suitable for performing the gaming functions in accordance with the present invention typically includes a central processor (CPU) 802 coupled to random access memory (RAM) 804 and some variation of read-only memory (ROM) 806. The ROM 806 may also represent other types of storage media to store programs, such as programmable ROM (PROM), erasable PROM (EPROM), etc. The processor 802 may communicate with other internal and external components through input/output (I/O) circuitry 808 and bussing 810, to provide control signals, communication signals, and the like.

The computing arrangement 800 may also include one or more data storage devices, including hard and floppy disk drives 812, CD-ROM drives 814, card reader 815, and other hardware capable of reading and/or storing information such as DVD, etc. In one embodiment, software for carrying out the operations in accordance with the present invention may be stored and distributed on a CD-ROM 816, diskette 818, access card 819, or other form of computer readable media capable of portably storing information. These storage media may be inserted into, and read by, devices such as the CD-ROM drive 814, the disk drive 812, card reader 815, etc. The software may also be transmitted to the computing arrangement 800 via data signals, such as being downloaded electronically via a network, such as the Internet. Further, as previously described, the software for carrying out the functions associated with the present invention may alternatively be stored in internal memory/storage of the computing device 800, such as in the ROM 806.

The computing arrangement 800 is coupled to the display 811, which represents a display on which the gaming activities in accordance with the invention are presented. The display 811 represents the “presentation” of the video information in accordance with the invention, and may be any type of known display or presentation screen, such as liquid crystal displays, plasma displays, cathode ray tubes (CRT), digital light processing (DLP) displays, liquid crystal on silicon (LCOS) displays, etc.

Where the computing device 800 represents a stand-alone or networked computer, the display 811 may represent a standard computer terminal or display capable of displaying multiple windows, frames, etc. Where the computing device is embedded within an electronic gaming machine, the display 811 corresponds to the display screen of the gaming machine/kiosk. A user input interface 822 such as a mouse, keyboard/keypad, microphone, touch pad, trackball, joystick, touch screen, voice-recognition system, etc. may be provided. The display 811 may also act as a user input device, e.g., where the display 811 is a touchscreen device. In embodiments, where the computing device 800 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 802, or some combination of hardware and software. The present invention is operable using any known RNG, and may be integrally programmed as part of the processor 802 operation, or alternatively may be a separate RNG controller 840.

The computing arrangement 800 may be connected to other computing devices or gaming machines, such as via a network. The computing arrangement 800 may be connected to a network server 828 in an intranet or local network configuration. The computer may further be part of a larger network configuration as in a global area network (GAN) such as the Internet. In such a case, the computer may have access to one or more web servers via the Internet. In other arrangements, the computing arrangement 800 may be configured as an Internet server and software for carrying out the operations in accordance with the present invention may interact with the player via one or more networks. The computing arrangement 800 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 800 may also include a hopper controller 842 to determine the amount of payout to be provided to the participant. The hopper controller may be integrally implemented with the processor 802, or alternatively as a separate hopper controller 842. A hopper 844 may also be provided in gaming machine embodiments, where the hopper serves as the mechanism holding the coins/tokens of the machine. The wager input module or device 846 represents any mechanism for accepting coins, tokens, coupons, bills, electronic fund transfer (EFT), tickets, credit cards, smart cards, membership/loyalty cards, etc., for which a participant inputs a wager amount. The wager input device 846 may include magnetic strip readers, bar code scanners, light sensors, or other detection devices to identify and validate physical currency, currency-based tickets, cards with magnetized-strips, or other medium inputted into the wager input device. When a particular medium is received in the wager input device 846, a signal may be generated establish or increase an available credit amount stored in the internal memory/storage of the computing device 800, such as in the RAM 804. Thereafter, specific wagers placed on games may reduce the available credit amount, while awards won may increase the available credit amount. It will be appreciated that the primary gaming software 832 may be able to control payouts via the hopper 844 and controller 842 for independently determined payout events.

Among other functions, the computing arrangement 800 provides an interactive experience to players via input interface 822 and output devices, such as the display 811, speaker 830, etc. These experiences are generally controlled by gaming software 832 that controls a primary gaming activity of the computing arrangement 800. The gaming software 832 may be temporarily loaded into RAM 804, and may be stored locally using any combination of ROM 806, drives 812, media player 814, or other computer-readable storage media known in the art. The primary gaming software 832 may also be accessed remotely, such as via the server 828 or the Internet.

The primary gaming software 832 in the computing arrangement 800 is shown here as an application software module. According to embodiments of the present invention, this software 832 provides a slot game or similar game of chance as described hereinabove. For example, the software 832 may present, by way of the display 811, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 832 may include instructions to provide other functionality as known in the art and described herein, such as shown and described above regarding FIGS. 1-7.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a game display;
a wager input device structured to receive physical currency or currency based tickets, the currency or currency based tickets establishing a credit balance, the credit balance being increasable or decreasable based at least on wagering activity; and
a processor configured to:
receive a signal to initiate a primary game of change in response to placement of a wager, the wager decreasing the credit balance;
determine an outcome for the primary game of chance;
initiate a bonus event when a trigger condition is satisfied, the bonus event including a secondary game;
determine an amount of a mystery award based on an outcome of a virtual game played by the processor;
present on the game display an option to play the secondary game and an option to receive the mystery award, where the amount of mystery award is not shown on the game display;
present the secondary game for play when the option to play the secondary game is selected; and
present the amount of the mystery award and end the bonus event when the option to receive the mystery award is selected.

2. The gaming device of claim 1, wherein determining an amount of the mystery award includes:
determining a quantity value associated with the secondary game; and
playing the virtual game based on the quantity value associated with the secondary game.

3. The gaming device of claim 1, wherein the secondary game includes a plurality of game stages.

4. The gaming device of claim 3, wherein a new amount of the mystery award is determined after each of the plurality of game stages in the secondary game when the option to play the secondary game is selected.

5. The gaming device of claim 4, wherein the processor is further configured to present an option to keep playing the secondary game and an option to receive the mystery award with new determined amount after each game stage of secondary game.

6. The gaming device of claim 3, wherein presenting an option to play the secondary game and an option to receive the mystery award includes presenting a first option to play the secondary game with each of the plurality of game stages associated with the secondary game and presenting a second option to play the secondary game with less than the plurality of game stages associated the secondary game where amounts won in each game stage are multiplied by a multiplier.

7. The gaming device of claim 6, wherein the second option to play the secondary game includes half of the game stages played with a multiplier that doubles any awards won in the game stages.

8. The gaming device of claim 7, wherein the second option includes a remainder game stage played without the multiplier if the plurality of game stages associated with the secondary game is not evenly divisible by 2.

9. The gaming device of claim 1, wherein the secondary game is a free spins bonus game where a plurality of games may be played without placement of an additional wager.

10. The gaming device of claim 1, wherein the secondary game is a pick bonus game where a plurality selectable items are displayed on the game display.

11. The gaming device of claim 1, wherein the processor is further configured to:
determine a minimum value for the amount of the mystery award; and
display the minimum value when presenting the option to play the secondary game and the option to receive the mystery award.

12. The gaming device of claim 11, wherein the processor is further configured to:
determine a maximum value for the amount of the mystery award; and
display the maximum value when presenting the option to play the secondary game and the option to receive the mystery award.

13. The gaming device of claim 1, wherein presenting an option to play the secondary game and an option to receive the mystery award includes presenting a first option to receive a first mystery award and a second option to receive a second mystery award, where the amounts of the first mystery award and second mystery award are not shown on the game display.

14. The gaming device of claim 13, wherein an amount of the second mystery award is independently determined from the first mystery award and is based on another outcome of the virtual game played by the processor.

15. The gaming device of claim 13, wherein an amount of the second mystery award is determined based off of the amount determined for the first mystery award by play of the virtual game.

16. The gaming device of claim 1, wherein the virtual game has substantially identical game rules to a set of game rules used for the secondary game.

17. A gaming device comprising:
a memory configured to store a plurality of game reels and a plurality of game rules;
a game display having a game grid showing portions of the plurality of game reels;
a random number generator configured to continually generate numeric outcomes at random; and
a processor configured to:
initiate a gaming event having a plurality of game stages;
determine a number of game stages associated with the gaming event;
repeatedly play a virtual game according to the plurality of game rules stored in the memory using random numeric outcomes from the random number generator based on the determined number of game stages associated with the gaming event;
determine an amount of a mystery award based on virtual amounts awarded in the repeated play of the virtual game;
present on the game display an option to play each stage of the gaming event and an option to receive the mystery award, where the amount of mystery award is not shown on the game display;
present a first stage of the gaming event when the option to play each stage of the game event is selected; and
present the amount of the mystery award and end the gaming event when the option to receive the mystery award is selected.

18. The gaming device of claim 17, wherein each stage of the gaming event is a separate spin of the plurality of game reels, where outcomes of the spins is determined using random numeric outcomes from the random number generator and are displayed in the game grid of the game display.

19. The gaming device of claim 18, wherein the memory is further configured to store a plurality of bonus reels, wherein the bonus reels are used in the play of the virtual game.

20. A gaming device comprising:
a memory configured to store a plurality of game reels, a plurality of game rules, and plurality of virtual game rules;
a game display having a game grid showing portions of the plurality of game reels;
a random number generator configured to continually generate numeric outcomes at random;
a wager input device structured to receive physical currency or currency based tickets, the currency or currency based tickets establishing a credit balance, the credit balance being increasable or decreasable based at least on wagering activity; and
a processor configured to:
receive a signal to initiate a primary gaming event using the game reels in response to placement of a wager, the wager decreasing the credit balance;
determine an outcome for the primary game of chance according the game rules stored in the memory using random numeric outcomes from the random number generator and displaying the determined outcome by stopping the game reels in the game grid of the game display;
initiate a bonus event when a trigger condition is satisfied, the bonus event including a secondary game including a plurality of free games played without requiring an additional wager, where a number of free games included in the secondary game is based on the triggering condition;
determine the number of free games associated with the triggering condition;
determine a number of virtual spins based on the determined number of free spins;
repeatedly play a virtual game according to the plurality of virtual game rules stored in the memory using random numeric outcomes from the random number generator for the determined number of virtual spins, wherein virtual awards from the play of the virtual games is accumulated in a bonus meter;
determine an amount of a mystery award based the value of the bonus meter;
present on the game display an option to play the secondary game and an option to receive the mystery award, where the amount of mystery award is not shown on the game display;
present the secondary game for play when the option to play the secondary game is selected; and
present the amount of the mystery award and end the bonus event when the option to receive the mystery award is selected.
